(19) United States
(12) Patent Application Publication
(10) Pub. No.: US 2026/0336973 A1
(43) Pub. Date: Oct. 29, 2026

(54) INFOTAINMENT CONTENT MANAGEMENT SYSTEMS FOR ELEVATORS

(71) Applicant: TK ELEVATOR INNOVATION AND OPERATIONS GMBH, Düsseldorf (DE)

(72) Inventor: Monil Dinesh Morar, Houston, TX (US)

(73) Assignee: TK ELEVATOR INNOVATION AND OPERATIONS GMBH, Düsseldorf (DE)

(21) Appl. No.: 19/114,268

(22) PCT Filed: Oct. 5, 2023
(86) PCT No.: PCT/EP2023/077651

§ 371 Date: Mar. 21, 2025

Related U.S. Application Data
(60) Provisional application No. 63/378,548, filed on Oct. 6, 2022.

(51) Int. Cl. B66B 3/00; B66B 1/34

(52) U.S. Cl. CPC B66B 3/008; B66B 1/3407

(57) ABSTRACT

Embodiments of the present disclosure are directed to an elevator system that includes an elevator controller, a device gateway, and a compute device. The elevator controller may control operation of an elevator car. The compute device may receive elevator status information from the elevator controller. The compute device may receive a modified configuration file from the device gateway. The compute device may replace a stored configuration file with the modified configuration file, and display the elevator status information or infotainment content based on the modified configuration file.

### CROSS-REFERENCE TO RELATED APPLICATION

This application claims the benefit of and priority to U.S. Application Ser. No. 63/378,548 filed Oct. 6, 2022, and entitled “Infotainment Content Management System for Elevators”, the entire contents of which are incorporated by reference in the present disclosure.

### TECHNICAL FIELD

The present disclosure generally relates to infotainment systems, and more particularly, to an infotainment content management system for elevators.

### BACKGROUND

An elevator may include a screen that displays news, entertainment, and other information to elevator passengers. It may be desirable to easily update and manage the information presented on such a screen. Accordingly, a need exists for an improved infotainment content management system for elevators.

### SUMMARY

In one embodiment, an elevator system may include an elevator controller, a device gateway, and a compute device. The elevator controller may control operation of an elevator car. The compute device may store a configuration file. The compute device may include a first processing device and a first non-transitory, processor-readable storage medium. When executed, the storage medium may cause the first processing device to receive elevator status information from the elevator controller, receive, from the device gateway, a modified configuration file associated with information to be displayed, replace the configuration file with the modified configuration file, and cause a display device inside the elevator car to display the elevator status information or infotainment content based on the modified configuration file.

In another embodiment, a method may include receiving elevator status information from an elevator controller associated with an elevator car, receiving, from a device gateway, a modified configuration file associated with information to be displayed, replacing a configuration file with the modified configuration file, and causing a display device inside the elevator car to display the elevator status information or infotainment content based on the modified configuration file.

In another embodiment, a system may include a remote computing device and an elevator system. The elevator system may include an elevator controller, a device gateway, and a compute device. The elevator controller may control operation of an elevator car. The compute device may store a configuration file. The compute device may include a first processing device and a first non-transitory, processor-readable storage medium. When executed, the storage medium may cause the first processing device to receive elevator status information from the elevator controller, receive, from the device gateway, a modified configuration file associated with information to be displayed, replace the configuration file with the modified configuration file, and cause a display device inside the elevator car to display the elevator status information or infotainment content based on the modified configuration file

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1A schematically depicts a first aspect of an example elevator assembly schematic, according to one or more embodiments shown and described herein;

FIG. 1B schematically depicts a second aspect of an example elevator assembly schematic, according to one or more embodiments shown and described herein;

FIG. 2 depicts an example display inside an elevator, according to one or more embodiments shown and described herein;

FIG. 3 depicts an example infotainment content management system for elevators, according to one or more embodiments shown and described herein;

FIG. 4 schematically depicts an example remote computing device, according to one or more embodiments shown and described herein;

FIG. 5 depicts an example elevator system, according to one or more embodiments shown and described herein;

FIG. 6 depicts an example device gateway, according to one or more embodiments shown and described herein;

FIG. 7 depicts an example compute device, according to one or more embodiments shown and described herein;

FIG. 8 depicts a flow chart of an example method for operating the remote computing device of FIG. 4, according to one or more embodiments shown and described herein;

FIG. 9 depicts a flow chart of an example method for operating the device gateway of FIG. 6, according to one or more embodiments shown and described herein;

FIG. 10 depicts a flow chart of an example method for operating the compute device of FIG. 7, according to one or more embodiments shown and described herein; and

FIG. 11 depicts an example display inside an elevator when emergency services are ongoing, according to one or more embodiments shown and described herein.

### DETAILED DESCRIPTION

Embodiments of the present disclosure are directed to infotainment content management systems for elevators. An elevator may contain one or more screens that display information to occupants, such as news, weather, entertainment, and the like (referred to herein as infotainment or infotainment content). This infotainment content may be received from a cloud server. In embodiments, a facility manager associated with one or more elevators may update the layout or other settings associated with an infotainment display by remotely accessing a user portal. Once the facility manager makes the appropriate updates via the user portal, the cloud server transmits a configuration file to one or more associated elevators. The elevator may receive the configuration file and update the display, as disclosed herein. As such, in the embodiments disclosed herein, an elevator infotainment display may be easily updated by a user remotely without needing to visit the elevator.

The phrase “communicatively coupled” is used herein to describe the interconnectivity of various components of the monitoring system for elevator assemblies and means that the components are connected either through wires, optical fibers, or wirelessly such that electrical, optical, data, and/or electromagnetic signals may be exchanged between the components. It should be understood that other means of connecting the various components of the system not specifically described herein are included without departing from the scope of the present disclosure.

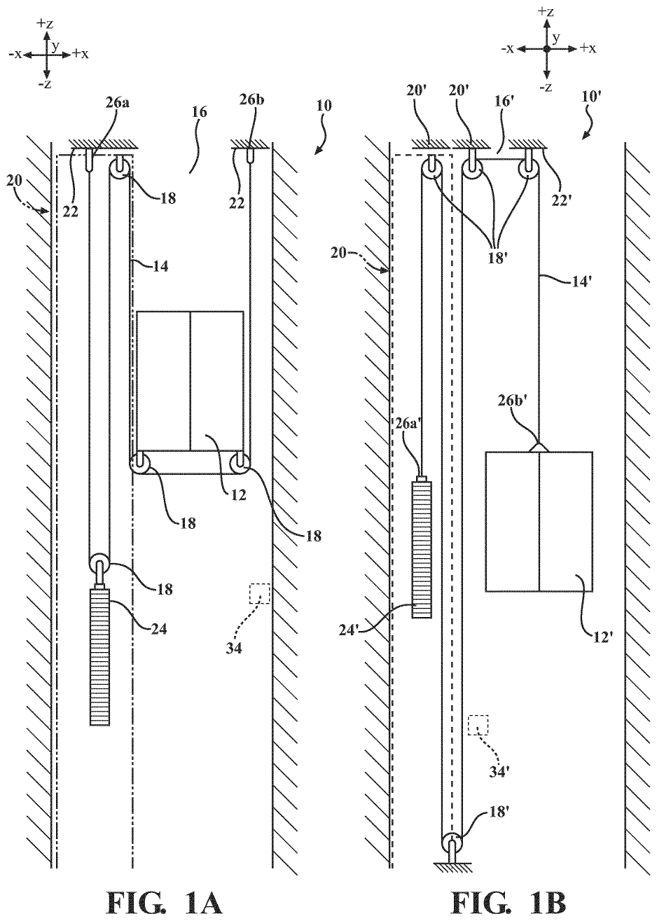

Referring now to the drawings, FIG. 1A depicts an elevator assembly schematic that illustrates various components for a first aspect of an example elevator assembly 10. In this aspect, the example elevator assembly 10 may include an elevator cab 12, a plurality of elevator hoisting members 14 illustrated for schematic reasons as a single suspension member and herein referred to as hoisting members, a hoistway 16 or elevator shaft, a plurality of sheaves 18, an example frame 20, and a plurality of weights 24 that act as a counterweight to the elevator cab 12. The plurality of weights 24 move within the example frame 20 in the system vertical direction (i.e., in the +/−Z direction). The example frame 20 may be an elevator frame, a counterweight elevator frame, and/or the like, as discussed in greater detail herein. The plurality of elevator hoisting members 14 include a distal end 26a and a proximate end 26b.

Further, in this aspect, as illustrated and without limitation, the example frame 20 includes two sheaves of the plurality of sheaves 18. For example, one sheave is fixedly mounted to an upper portion of the example frame 20 positioned in an upper portion of the hoistway 16 above the elevator cab 12 in a vertical direction (i.e., in the +/−Z direction) and another sheave moves with the weights 24 as the elevator cab 12 moves between various landings. This is non-limiting, and any number of the plurality of sheaves 18 may be mounted anywhere within the hoistway 16 and there may be more than or less than the two sheaves illustrated as being in the example frame 20.

At least one of the plurality of sheaves 18 within the hoistway 16 may include a motor such that the sheave is a traction sheave capable of driving the plurality of elevator hoisting members 14 through a plurality of lengths between the elevator cab 12 and the traction sheave. Further, the plurality of sheaves 18 may further include a plurality of idler sheaves that may also be mounted at various positions in the hoistway 16, and, in this aspect, are also coupled to the elevator cab 12. Idler sheaves are passive (they do not drive the elevator hoisting members 14, but rather guide or route the plurality of elevator hoisting members 14) and form a contact point, or engagement point, with the elevator cab 12. The plurality of elevator hoisting members 14 and the plurality of sheaves 18 move the elevator cab 12 between a plurality of positions within the hoistway 16 including to a plurality of landings. The plurality of sheaves 18 may include any combination of traction type sheaves and idler type sheaves. At least one temperature sensor 34 may be positioned within the hoistway 16. The at least one temperature sensor 34 may output data indicative to a temperature within the hoistway 16.

As illustrated in FIG. 1A, the elevator assembly 10 is an underslung system, with the idler sheaves positioned on a bottom surface of the elevator cab 12. Each of the plurality of elevator hoisting members 14 may be movably coupled to the traction sheave and a portion of the plurality of elevator hoisting members 14 may be coupled to the bottom surface of the elevator cab 12 to suspend the elevator cab 12 via the idler sheaves. As such, the elevator hoisting members 14 pass under the elevator cab 12 on a bottom of the elevator cab 12 via the idler sheaves, and are coupled at the top of the hoistway 16 under tension to various structures, such as to the example frame 20, a plurality of rail caps 22, and/or the like. For example, the proximate end 26b of the plurality of elevator hoisting members 14 may be fixedly coupled to the rail caps 22 and the movably coupled portion of the plurality of elevator hoisting members 14 are under tension to move the elevator cab 12 between various landings. The example frame 20 may include a dead end hitch, at least one of the plurality of rail caps 22, or other structural components.

Referring now to FIG. 1B, a schematic illustrating various components for a second aspect of an example elevator assembly 10′ is depicted. It should be appreciated that in the discussion herein, the elevator assembly 10, and components thereof, may refer to either elevator assembly 10, 10′. In this aspect, the elevator assembly 10′ may include an elevator cab 12′, a plurality of elevator hoisting members 14′ illustrated for schematic reasons as a single suspension member, a hoistway 16′ or elevator shaft, a plurality of sheaves 18′, such as traction sheaves and/or idler sheaves, an example grounded frame 20′, and a plurality of weights 24′ that move within the example frame 20′ in the system vertical direction (i.e., in the +/−Z direction). In this aspect, the plurality of elevator hoisting members 14′ extend a length between the weights 24′ and the elevator cab 12′. Further, in this aspect, at least one of the plurality of sheaves 18′ is a traction sheave, which, for example, may be mounted to a lower surface of the hoistway 16′. This is non-limiting, and the traction sheave of the plurality of sheaves 18′ may be mounted anywhere within the hoistway 16′ and the plurality of sheaves 18′ may include a plurality of idler sheaves and at least one traction sheave. It should be appreciated that the traction sheave may include a motor such that at least one of the plurality of sheaves 18′ is a device to drive the plurality of elevator hoisting members 14′ through a plurality of lengths with respect to the length between the traction sheave and the contact point of the elevator cab 12′. The idler sheaves may also be mounted at various positions in the hoistway 16′ including within the example frame 20′. The idler sheaves are passive (they do not drive the plurality of elevator hoisting members 14′ but rather guide or route the plurality of elevator hoisting members 14′). The plurality of elevator hoisting members 14′ are coupled to the elevator cab 12′ to form the contact point. At least one temperature sensor 34′ may be positioned within the hoistway 16′. The at least one temperature sensor 34′ may output data indicative to a temperature within the hoistway 16′.

It should be appreciated that the illustrated schematics of FIGS. 1A-1B are merely examples and that the plurality of elevator hoisting members 14 routing may vary significantly or slightly from these illustrated schematics. For example, there may be several idler sheaves positioned in the hoistway 16 between the traction sheave and the contact point with the elevator cab 12.

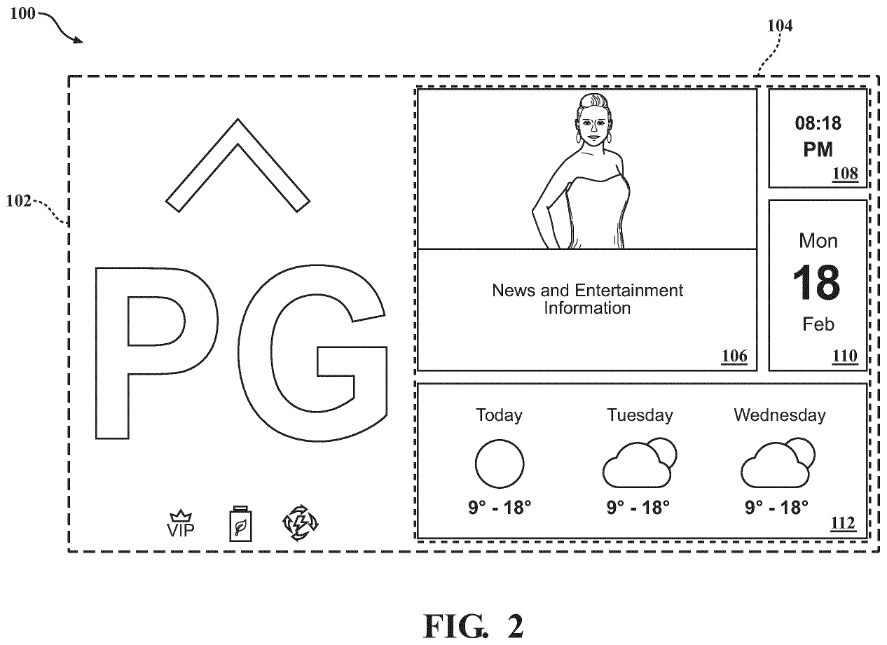

Referring now to FIG. 2, an example display 100 is shown that may be displayed on a screen or other display device inside the elevator cab 12. This may make elevator rides more pleasant for passengers by providing them with news, entertainment, and other information while riding in the elevator.

In the example of FIG. 2, the display 100 includes a first display region 102 and a second display region 104. In the example of FIG. 2, the first display region 102 displays information about operation of the elevator, and the second display region 104 displays infotainment content. In the example of FIG. 2, the first display region 102 indicates that the elevator is traveling up from the parking garage. The second display region 104 includes a plurality of widgets that each display different news, entertainment, or other types of information.

In the example of FIG. 2, the second display region 104 includes widgets 106, 108, 110, 112. Widget 106 displays news and entertainment information, widget 108 displays a current time, widget 110 displays a current date, and widget 112 displays weather information. However, in other examples, the second display region 104 may include more widgets, fewer widgets, or other types of widgets with other information. In some examples, the second display region 104 may display information related to emergency services. Operation of the display 100 is disclosed in further detail below.

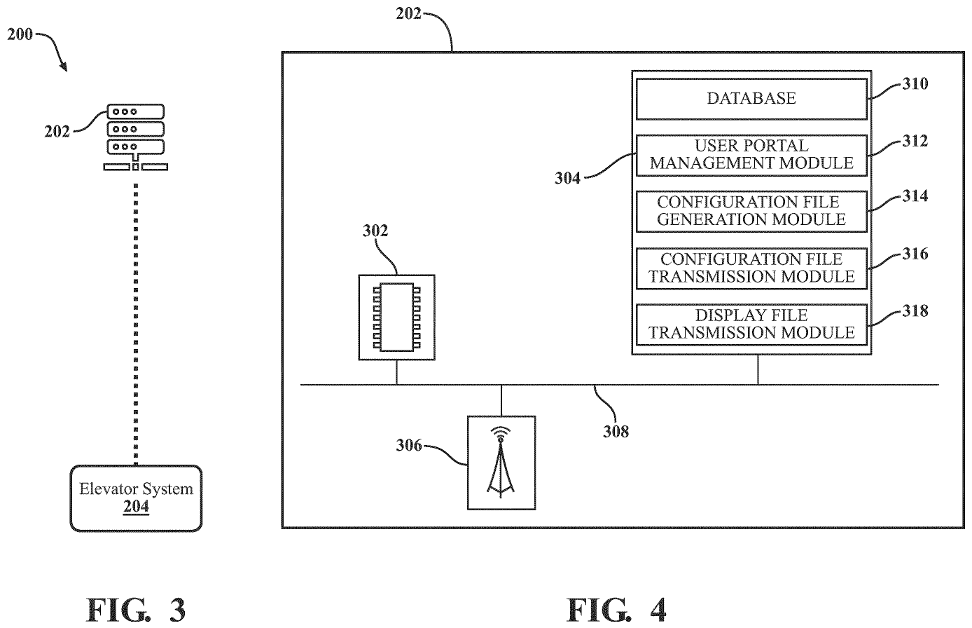

Referring now to FIG. 3, an infotainment content management system 200 is shown. The infotainment content management system 200 includes a remote computing device 202 and an elevator system 204. In embodiments, the elevator system 204 comprises an elevator (e.g., the elevator assembly 10 of FIG. 1A or the elevator assembly 10′ of FIG. 1B) with an infotainment display, such as the display 100 of FIG. 2. The remote computing device 202 may provide infotainment content to the elevator system 204, as disclosed herein. The remote computing device 202 and the elevator system 204 may be communicatively coupled to each other, for example via the Internet, an Intranet, or other types of communications. The remote computing device 202 and the elevator system 204 are described in further detail below.

Now referring to FIG. 4, the remote computing device 202 is schematically depicted. In the illustrated example, the remote computing device 202 comprises a cloud computing server. However, in other examples, the remote computing device 202 may comprise any other type of computing device. In the illustrated example, the remote computing device 202 is located remotely from the elevator system. However, in some examples, the remote computing device 202 may be located in the same location as the elevator system 204.

In the example of FIG. 4, the remote computing device 202 may be one or more remote computing devices 202 and may include one or more processors 302, one or more memory modules 304, network interface hardware 306, and a communication path 308. The one or more processors 302 may be a controller, an integrated circuit, a microchip, a computer, a central processing unit (CPU), or any other computing device. The one or more memory modules 304 may comprise RAM, ROM, flash memories, hard drives, or any device capable of storing machine readable and executable instructions such that the machine readable and executable instructions can be accessed by the one or more processors 302.

The network interface hardware 306 can be communicatively coupled to the communication path 308 and can be any device capable of transmitting and/or receiving data via a network. Accordingly, the network interface hardware 306 can include a communication transceiver for sending and/or receiving any wired or wireless communication. For example, the network interface hardware 306 may include an antenna, a modem, LAN port, Wi-Fi card, WiMax card, mobile communications hardware, near-field communication hardware, satellite communication hardware and/or any wired or wireless hardware for communicating with other networks and/or devices. The network interface hardware 306 of the remote computing device 202 may transmit data to and receive data from the elevator system 204.

The one or more memory modules 304 include a database 310, a user portal management module 312, a configuration file generation module 314, a configuration file transmission module 316, and a display file transmission module 318. Each of the database 310, the user portal management module 312, the configuration file generation module 314, the configuration file transmission module 316, and the display file transmission module 318 may be a program module in the form of operating systems, application program modules, and other program modules stored in the one or more memory modules 304. In some embodiments, the program module may be stored in a remote storage device that may communicate with the remote computing device 202. Such a program module may include, but is not limited to, routines, subroutines, programs, objects, components, data structures and the like for performing specific tasks or executing specific data types as will be described below.

The database 310 may store data associated with user accounts. In particular, the remote computing device 202 may be associated with a plurality of elevator systems associated with a plurality of users. For example, a building owner may establish an account with the remote computing device 202 in order to manage infotainment content for all of the elevators in the building. As such, the building owner may establish an account with the remote computing device 202 in order to access a user portal for managing infotainment for the building elevators, as disclosed herein. As such, the database 310 may store user names, passwords, and other information that may allow users to log in to the user portal. The database 310 may also store other data used by the memory modules 304.

The user portal management module 312 may manage the user portal, as disclosed herein. As discussed above, various users may establish accounts with the remote computing device 202 to manage infotainment for one or more elevators. In particular, users may log in to the user portal and update settings or other information to modify the layout and/or types of information to be displayed by one or more elevators (e.g., as shown in the display 100 of FIG. 2).

The user portal management module 312 may manage the user portal. In embodiments, the user portal management module 312 may allow users to log in to their user accounts. After a user logs in to their account, the user portal management module 312 may allow the user to modify the infotainment display (e.g., the second display region 104 of FIG. 2) of one or more elevators. In some examples, the user portal management module 312 may present a graphical user interface (GUI) to a user who has logged into their user account. The GUI may allow the user to modify the infotainment display. In other examples, the user portal management module 312 may allow the user to modify the infotainment display using text or other types of input.

In embodiments, the user portal management module 312 may allow users to modify a variety of settings that affect an elevator infotainment display. In one example, with respect to the infotainment display in the second display region 104 of FIG. 2, a user may modify the size and location of the widgets 106, 108, 110, 112. In another example, a user may modify language settings to cause text of the infotainment display to be in a certain language. In another example, a user may modify a location setting, such that news, weather, and other information displayed are related to a selected location. In another example, a user may specify time and date formats (e.g., 12-hour time, 24-hour time, American style dates, European style dates, and the like) for displaying the time and date. In another example, a user may specify the type of news or specific news items to display. In another example, a user may specify specific messages to be displayed (e.g., messages associated with the building the elevator is in). In other examples, the user portal management module 312 may allow users to modify other settings associated with an infotainment display or infotainment content.

Referring back to FIG. 4, the configuration file generation module 314 may generate or modify a configuration file based on information entered by a user through the user portal. In particular, the configuration file generation module 314 may generate or modify a configuration file that specifies settings for an infotainment display. In the illustrated embodiment, the configuration file generation module 314 generates a JavaScript Object Notation (JSON) file as the configuration file. In other examples, the configuration file generation module 314 may generate the configuration file using other data formats.

The configuration file generated by the configuration file generation module 314 may specify parameters (e.g., as discussed above), that affect the infotainment display and/or infotainment content. Whenever a user logs in to the user portal and modifies any infotainment settings, the configuration file generation module 314 generates a modified configuration file (e.g., a JSON file). The modified configuration file may be used by the elevator system 204 to modify the infotainment display, as discussed in further detail below.

Referring still to FIG. 4, the configuration file transmission module 316 may transmit a modified configuration file generated by the configuration file generation module 314 to the elevator system 204. The elevator system 204 may receive the transmitted configuration file, and use the configuration file to affect infotainment settings, as discussed in further detail below.

Referring still to FIG. 4, the display file transmission module 318 may transmit a display file to the elevator system 204, as disclosed herein. In embodiments, the elevator system 204 may store a display file (which may be referred to herein as an infotainment display file) that causes an elevator screen to display infotainment content (e.g., as shown in the second display region 104 of FIG. 2. In the illustrated example, the display file is a HyperText Markup Language (HTML) file. However, in other examples, the display file may be in other data formats.

In embodiments, the display file may be an HTML file that causes a screen inside the elevator cab 12 to display infotainment content. In particular, the display file may access the configuration file to determine specific information to be displayed. For example, the display file may be an HTML file that specifies that widget 106 of FIG. 2 should display a news item from a Uniform Resource Locator (URL) specified in the configuration file. As such, when the elevator system 204 reads the display file, it may access the configuration file to determine the URL from which to populate widget 106. The elevator system 204 may then access the specified URL to retrieve the information to be displayed by widget 106.

As such, setting information and minor updates to the infotainment display can be made by updating the configuration file as discussed above, whereas major updates to the infotainment display can be made by updating the display file. As such, if a major update to the infotainment display is to be made, the display file transmission module 318 may transmit an updated display file to the elevator system 204. In some examples, the user portal management module 312 may allow a user to modify the display file through the user portal. In other examples, the display file may be modified by other means (e.g., by a web designer) and may then be transmitted by the display file transmission module 318 to the elevator system 204.

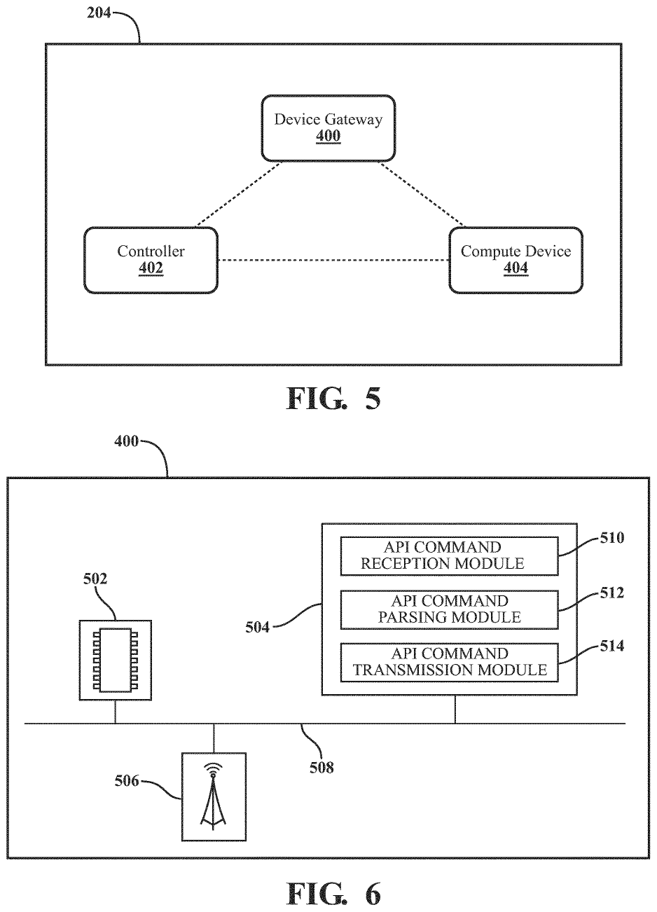

Referring now to FIG. 5, a schematic diagram of the elevator system 204 is illustrated. In the illustrated example, the elevator system 204 includes a device gateway 400, a controller 402, and a compute device 404.

The device gateway 400 acts as a gateway or interface to the elevator system 204. In particular, the device gateway 400 may receive Application Programming Interface (API) commands, parse the commands, and send the commands to the appropriate location. For example, the device gateway 400 may receive an API command from the remote computing device 202 to update infotainment settings. An API command received from the remote computing device 202 may include an updated configuration file as discussed above. Upon receiving such an updated configuration file, the device gateway 400 may parse the configuration file, identify that it is a configuration file associated with infotainment, and transmit the configuration file to the compute device 404, as discussed in further detail below.

The device gateway 400 may also receive other types of API commands not associated with infotainment. For example, the device gateway 400 may receive API commands associated with control of the elevator, and may parse these commands and transmit them to the controller 402. The device gateway 400 is discussed in further detail below in connection with FIG. 6.

The controller 402, which may also be referred to herein as an elevator controller, may control the operation of the elevator cab 12. In addition, the controller 402 may transmit information about the state of the elevator (e.g., the elevator cab 12) to the compute device 404 (e.g., the current floor and direction of travel of the elevator). This may allow the display 100 to include elevator status information in the infotainment display (e.g., in the first display region 102 of FIG. 2).

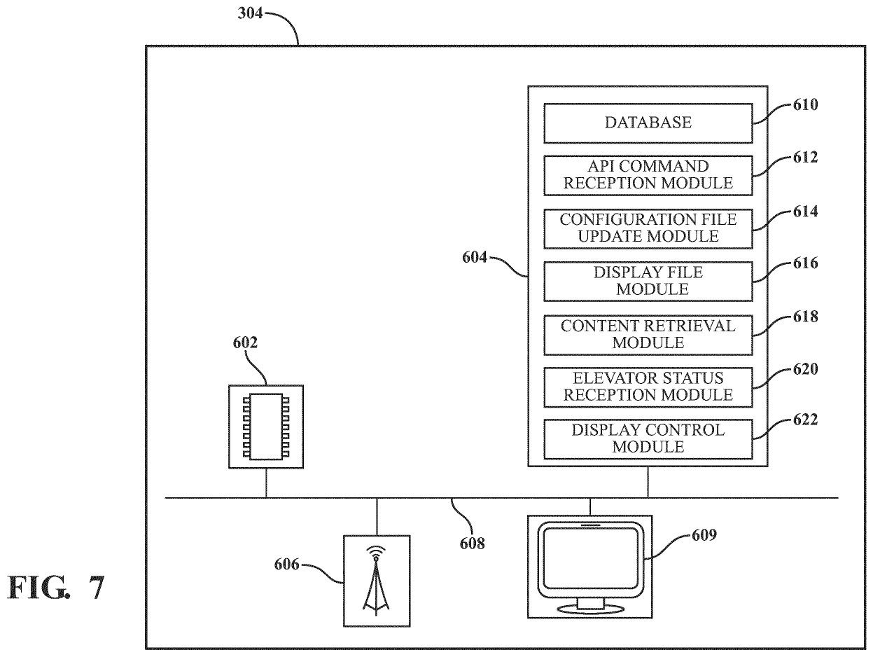

The compute device 404 may control the infotainment display, as disclosed herein. In particular, the compute device 404 may receive the configuration file from the device gateway 400 and/or elevator state information from the controller 402. The compute device 404 may use the received information to output infotainment information to a screen in the elevator cab 12. Operation of the compute device 404 is discussed in further detail below with respect to FIG. 7.

In embodiments, the controller 402, which controls operation of the elevator, and the compute device 404, which controls infotainment for the elevator, are separate devices. This isolates elevator control from infotainment control, thereby satisfying code requirements. As such, if any problems occur with the infotainment system, it will not affect operation of the elevator.

Turning now to FIG. 6, the device gateway 400 is schematically depicted. In the illustrated example, the device gateway 400 is located inside the elevator cab 12. In some examples, the device gateway 400 may be located inside a door jamb of the elevator. However, in other examples, the device gateway 400 may be located at other locations inside the elevator cab 12.

In the example of FIG. 6, the device gateway 400 comprises one or more processors 502, one or more memory modules 504, network interface hardware 506, and a communication path 508. The one or more processors 502 may be a controller, an integrated circuit, a microchip, a computer, or any other computing device. The one or more memory modules 504 may comprise RAM, ROM, flash memories, hard drives, or any device capable of storing machine readable and executable instructions such that the machine readable and executable instructions can be accessed by the one or more processors 502.

The network interface hardware 506 can be communicatively coupled to the communication path 508 and can be any device capable of transmitting and/or receiving data via a network. Accordingly, the network interface hardware 506 can include a communication transceiver for sending and/or receiving any wired or wireless communication. For example, the network interface hardware 506 may include an antenna, a modem, LAN port, Wi-Fi card, WiMax card, mobile communications hardware, near-field communication hardware, satellite communication hardware and/or any wired or wireless hardware for communicating with other networks and/or devices. The network interface hardware 506 of the device gateway 400 may transmit data to and receive data from the controller 402 and the compute device 404.

The one or more memory modules 504 include an API command reception module 510, an API command parsing module 512, and an API command transmission module 514. Each of the API command reception module 510, the API command parsing module 512, and the API command transmission module 514 may be a program module in the form of operating systems, application program modules, and other program modules stored in the one or more memory modules 504. In some embodiments, the program module may be stored in a remote storage device that may communicate with the device gateway 400. Such a program module may include, but is not limited to, routines, subroutines, programs, objects, components, data structures and the like for performing specific tasks or executing specific data types as will be described below.

The API command reception module 510 may receive API commands from the remote computing device 202 or other devices. In one examples, the API command reception module 510 may receive API commands from the remote computing device 202 related to infotainment, as discussed above. For example, the API command reception module 510 may receive an API command from the remote computing device 202 that includes a modified configuration file or a modified display file. In some examples, the API command reception module 510 may receive an API command related to operational control of the elevator. In other examples, the API command reception module 510 may receive API commands related to other operational features of the elevator system 204.

Referring still to FIG. 6, the API command parsing module 512 may parse API commands received by the API command reception module 510, as disclosed herein. In particular, the API command parsing module 512 may analyze the contents of an API command and determine the purpose of the API command and, correspondingly, where the API command should be routed. For example, if the API command reception module 510 receives an API command from the remote computing device 202 that includes an updated configuration file, the API command parsing module 512 may parse the received configuration, and determine that the configuration file is associated with infotainment and should be routed to the compute device 404. Similarly, if the API command reception module 510 receives an API command from the remote computing device 202 that includes an updated display file, the API command parsing module 512 may parse the received display file, and determine that it should be routed to the compute device 404. In another example, if the API command reception module 510 receives an API command associated with control of the elevator, the API command parsing module 512 may determine that the received API command should be routed to the controller.

Referring still to FIG. 6, the API command transmission module 514 may transmit an API command received by the API command reception module 510 to the appropriate device, as determined by the API command parsing module 512. For example, if the API command parsing module 512 determines that a received API command is associated with infotainment, the API command transmission module 514 may transmit the API command to the compute device 404. Alternatively, if the API command parsing module 512 determines that a received API command is associated with control of the elevator, the API command parsing module 512 may transmit the API command to the controller 402.

Turning now to FIG. 7, the compute device 404 is schematically depicted. In the illustrated example, the compute device 404 is located inside the elevator cab 12. As disclosed herein, the compute device 404 may control information displayed to users inside an elevator (e.g., as shown in FIG. 2).

In the example of FIG. 7, the compute device 404 comprises one or more processors 602, one or more memory modules 604, network interface hardware 606, a communication path 608, and a screen 609. The one or more processors 602 may be a controller, an integrated circuit, a microchip, a computer, or any other computing device. The one or more memory modules 604 may comprise RAM, ROM, flash memories, hard drives, or any device capable of storing machine readable and executable instructions such that the machine readable and executable instructions can be accessed by the one or more processors 602.

The network interface hardware 606 can be communicatively coupled to the communication path 608 and can be any device capable of transmitting and/or receiving data via a network. Accordingly, the network interface hardware 606 can include a communication transceiver for sending and/or receiving any wired or wireless communication. For example, the network interface hardware 606 may include an antenna, a modem, LAN port, Wi-Fi card, WiMax card, mobile communications hardware, near-field communication hardware, satellite communication hardware and/or any wired or wireless hardware for communicating with other networks and/or devices. The network interface hardware 606 of the compute device 404 may transmit data to and receive data from the device gateway 400 and the controller 402. In the illustrated example, the compute device 404 is communicatively coupled to the controller 402 via a Controller Area Network (CAN) bus and the compute device 404 is communicatively coupled to the device gateway 400 via an Ethernet connection. However, in other examples, the compute device 404 may be communicatively coupled to the controller 402 and the device gateway 400 via other communication modes.

The screen 609 may be located inside the elevator cab 12 and may display infotainment and other information, as disclosed herein. For example, the screen 609 may show the display 100 of FIG. 2.

The one or more memory modules 604 include a database 610, an API command reception module 612, a configuration file update module 614, a display file update module 616, a content retrieval module 618, an elevator status reception module 620, and a display control module 622. Each of the database 610, the API command reception module 612, the configuration file update module 614, the display file update module 616, the content retrieval module 618, the elevator status reception module 620, and the display control module 622 may be a program module in the form of operating systems, application program modules, and other program modules stored in the one or more memory modules 604. In some embodiments, the program module may be stored in a remote storage device that may communicate with the compute device 404. Such a program module may include, but is not limited to, routines, subroutines, programs, objects, components, data structures and the like for performing specific tasks or executing specific data types as will be described below.

The database 610 may store information to be utilized by the compute device 404 to control information to be displayed to the screen 609, as disclosed herein. As discussed above, infotainment to be displayed by the screen 609 is controlled by a display file (e.g., an HTML file) and a configuration file (e.g., a JSON file). The display file may include HTML or other commands to indicate information that should be displayed by the screen 609. The display file may reference the configuration file to determine settings or parameters that affect the display. Accordingly, the database 610 may store the display file and the configuration file in a file system of the compute device 404. In addition, the database 610 may also store a front end application that controls an overall display to be shown on the screen 609. The front end application is discussed in further detail below.

The API command reception module 612 may receive API commands from the device gateway 400, as discussed above. In particular, the API command reception module 612 may receive API commands that include a modified configuration file or a modified display file. Upon receipt of a modified configuration file, the configuration file update module 614 may update the configuration file stored on the database 610. Upon receipt of a modified display file, the display file update module 616 may update the display file stored on the database 610.

The content retrieval module 618 may retrieve content to be displayed by the screen 609, as specified in the configuration file. As discussed above, the configuration file may specify settings or parameters for information to be displayed by the screen 609. In particular, the configuration file may specify locations (e.g., URLs) to retrieve news, weather, and other information from. As such, the content retrieval module 618 may retrieve the appropriate news, weather, and other information from the specified locations. For example, the content retrieval module 618 may access a news server to retrieve news stores, a weather server to retrieve weather information, and the like. After the content retrieval module 618 retrieves specified content, the content may be displayed by on the screen 609, as disclosed herein.

The elevator status reception module 620 may receive a status of the elevator from the controller 402. As shown in the example of FIG. 2, the display 100 may include elevator status information in the first display region 102. Accordingly, the elevator status reception module 620 may continually receive elevator status information from the controller 402, which may be used to populate the appropriate section of the display shown on the screen 609. In the illustrated example, the elevator status reception module 620 may receive a current floor of the elevator and a direction of travel of the elevator from the controller 402. However, in other examples, the elevator status reception module 620 may receive other elevator status information from the controller 402.

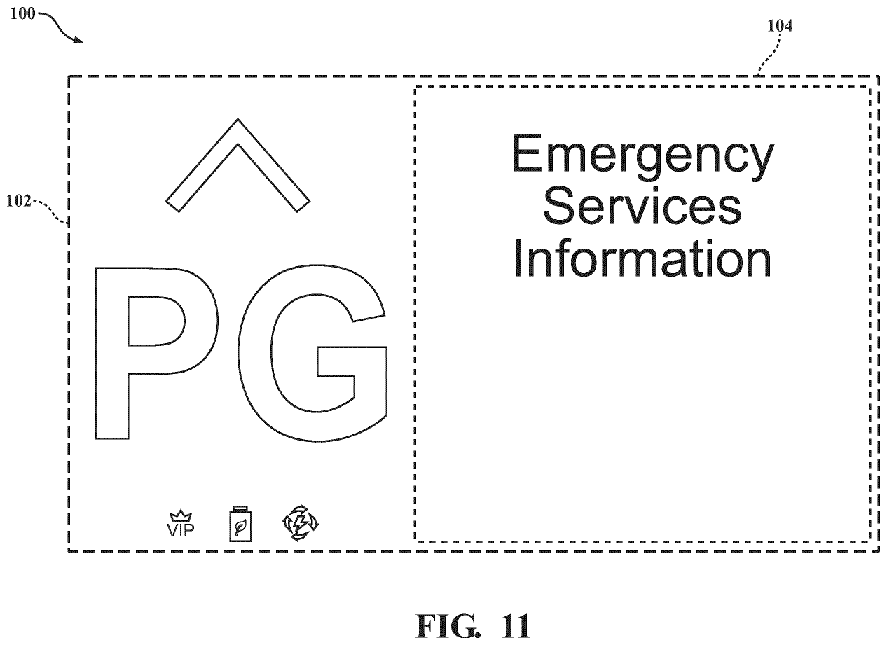

In some examples, when emergency services are initiated, the second display region 104 may display information about the emergency services. Such emergency services may include an emergency phone call, an elevator out of order, an earthquake mode, a fire mode, evacuation, a service mode, and the like. In these examples, when emergency services have been initiated, the elevator status reception module 620 may receive information about the emergency services from the controller 402 in addition to the other information that is continually received from the controller 402, as discussed above. The received emergency services information may then be displayed in the second display region 104. In particular, when emergency services have been initiated, the emergency services information received from the controller 402 may override the infotainment information such that the second display region 104 displays only the emergency services information. FIG. 11 shows an example of the display 100 when emergency services information is displayed in the second display region 104. After emergency services have been ended, the second display region 104 may go back to displaying the infotainment information based on the display file and the configuration file, as discussed above.

The display control module 622 may control the information displayed on the screen 609, as disclosed herein. In embodiments, the display control module 622 may execute the front end application stored on the database 610 to control the overall display on the screen 609. In the example of FIG. 2, the front end application may cause the first display region 102 to display elevator status information, and may cause the second display region 104 to display infotainment. While the example of FIG. 2 shows the first display region 102 on the left portion of the display 100 and the second display region 104 on the right portion of the display 100, in other examples, the screen 609 may display elevator status information and infotainment in other configurations.

The elevator status information to be shown in the first display region 102 may be based on the elevator status information received by the elevator status reception module 620 from the controller 402. In particular, whenever the elevator status reception module 620 receives updated elevator status information, the front end application may cause the display control module 622 to update the first display region 102 with the updated elevator status information. As such, the first display region 102 may continually display up to date elevator status information.

The front end application may cause the display control module 622 to display infotainment in the second display region 104. In particular, the front end application may point to a front end object reference to be displayed in the second display region 104. In the illustrated example, the front end object reference may be an iFrame object. However, in other examples, the front end object reference may be another data structure.

In embodiments, the front end object reference essentially acts as a black box that simply points to an object to be displayed in the second display region 104. In the illustrated example, the front end object reference points to the display file stored in the database 610. As such, the display file can be updated to change what is displayed in the second display region 104 without needing to change the front end application. Furthermore, the configuration file can be updated to change the settings associated with the infotainment display without needing to change the front end application or the display file.

In embodiments, when the display file update module 616 updates the display file stored in the database 610, the front end object reference of the front end application will automatically be pointing to the new display file. As such, the display control module 622 will cause the display 100 to be refreshed based on the information in the new display file. Furthermore, when the configuration file update module 614 updates the configuration file stored in the database 610, the display file may cause the display control module 622 to refresh the display 100 based on the updated information in the configuration file. Accordingly, the elevator infotainment display may be easily and efficiently managed remotely by a user. In some examples, when emergency services have been initiated, the display control module 622 may cause the second display region 104 to display emergency services information received from the controller 402, as discussed above.

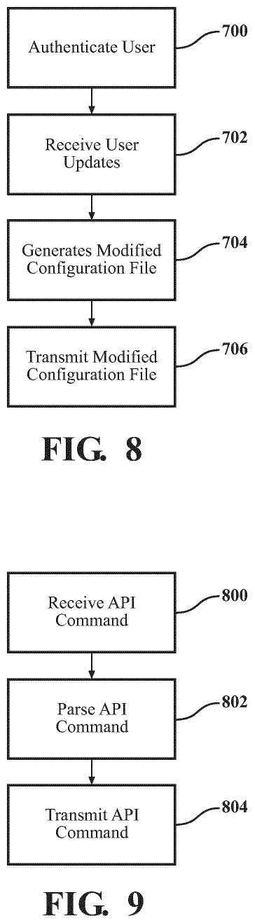

Turning now to FIG. 8, a flow chart is depicted of an example method that may be performed by the remote computing device 202. At step 700, the user portal management module 312 authenticates a user who logs into their user portal. Then, at step 702, the user portal management module 312 receives user updates. In particular, a user who is logged in to the user portal may submit changes to the settings and/or layout of an elevator infotainment display using the user portal.

At step 704, the configuration file generation module 314 generates a modified configuration file based on the user updates made by the user through the user portal. Then, at step 706, the configuration file transmission module 316 transmits the modified configuration file to the elevator system 204. In some examples, the display file transmission module 318 may also transmit an updated display file to the elevator system 204.

Turning now to FIG. 9, a flow chart is depicted of an example method that may be performed by the device gateway 400. At step 800, the API command reception module 510 receives an API command. In one example, the API command reception module 510 receives an API command related to infotainment from the remote computing device 202. In other examples, the API command reception module 510 may receive other types of API commands from the remote computing device 202 or from other computing devices.

At step 802, the API command parsing module 512 parses the API command received by the API command reception module 510. In particular, the API command parsing module 512 may analyze the received API command, and determine the purpose and appropriate routing of the API command. For example, the API command parsing module 512 may determine that the received API command includes a modified configuration file or a modified display file, and as such is related to infotainment and should be routed to the compute device 404. Alternatively, the API command parsing module 512 may determine that the received API command is related to elevator control and that it should be routed to the controller 402.

At step 804, the API command transmission module 514 transmits the received API command to the appropriate location, as determined by the API command parsing module 512. For example, if the API command parsing module 512 determines that the API command received by the API command reception module 510 is related to infotainment, the API command transmission module 514 may transmit the received API command to the compute device 404. Alternatively, if the API command parsing module 512 determines that the API command received by the API command reception module 510 is related to elevator control, the API command transmission module 514 may transmit the received API command to the controller 402.

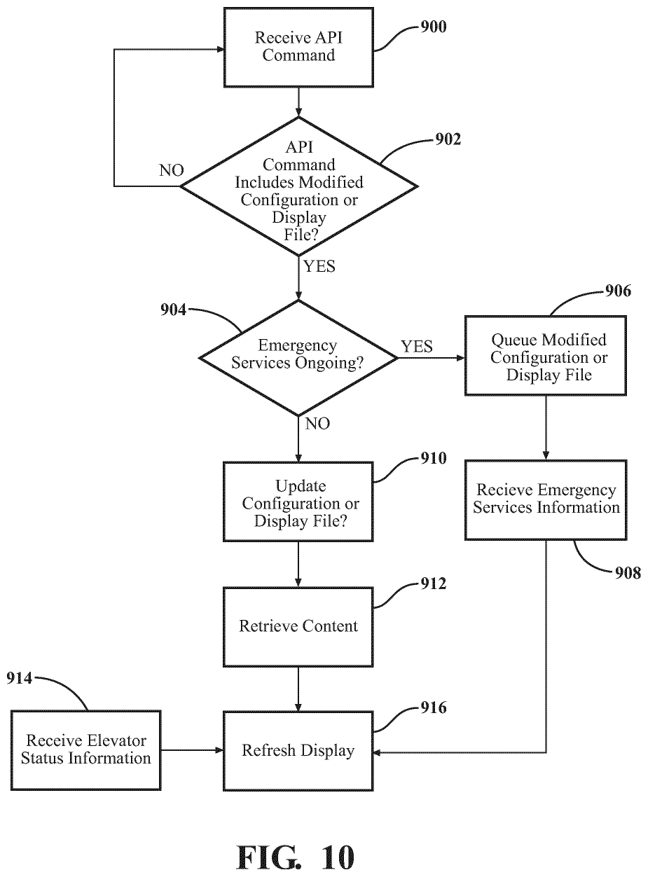

Turning now to FIG. 10, a flow chart is depicted of an example method that may be performed by the compute device 404.

At step 900, the API command reception module 612 receives an API command from the remote computing device 202. The API command received by the API command reception module 612 may include a modified configuration file and/or a modified display file.

At step 902, the configuration file update module 614 determines whether the received API command includes a modified configuration file or a modified display file. If the API command does not include a modified configuration file or a modified display file (NO at step 902), then control returns to step 900 until an API command is received that includes a modified configuration or display file. If the received API command does include a modified configuration file or display file (YES at step 902), then control passes to step 904.

At step 904, the elevator status reception module 620 determines whether emergency services are ongoing. For example, the elevator status reception module 620 may determine whether emergency services are ongoing based on whether emergency services information has been received from the controller 402. If emergency services are ongoing (YES at step 904), then control passes to step 906. If emergency services are not ongoing (NO at step 904), then control passes to step 910.

At step 906, after determining that emergency services are ongoing, the modified configuration file or modified display file received by the API command reception module 612 is queued until emergency services have ended. This is because, when emergency services are ongoing, the emergency services information has priority over infotainment. As such, the modified configuration file or modified display file are queued (e.g., in the database 610) until emergency services have ended. At step 908, the elevator status reception module 620 receives emergency services information from the controller 402.

At step 910, after determining that emergency services are not ongoing, if a modified configuration file was received, the configuration file update module 614 updates the database 610 with the modified configuration file. Alternatively, if a modified display file was received, the display file update module 616 updates the database 610 with the modified display file.

At step 912, the content retrieval module 618 retrieves content as specified by the configuration file. For example, the content retrieval module 618 may retrieve news items from a news server and/or weather information from a weather server.

At step 914, the elevator status reception module 620 receives elevator status information from the controller 402. For example, the elevator status reception module 620 may receive a current floor and traveling direction of the elevator, as discussed above.

At step 916, the display control module 622 refreshes the display on the screen 609. In particular, if emergency services are ongoing, the display control module 622 may refresh the display on the screen 609 to include the emergency services information in second display region 104, as shown in FIG. 11. Alternatively, if emergency services are not ongoing, the display control module 622 may refresh the display on the screen 609 based on the updated configuration file and/or display file to display updated infotainment information in the second display region 104. In either case, whether emergency services are ongoing or not, the first display region 102 may display elevator status information.

It should now be understood that embodiments disclosed herein provide infotainment content management systems for elevators. Users may remotely access a user portal to make changes to an infotainment display in one or more elevators. A modified configuration file may be transmitted from a cloud server to an elevator system to implement the changes without the need for a user to visit the elevators. A device in the elevator system controls the infotainment display, which is different from a separate device that controls elevator operation.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. An elevator system comprising:
an elevator controller configured to control operation of an elevator car;
a device gateway; and
a compute device storing a configuration file;
wherein the compute device comprises a first processing device, and a first non-transitory, processor-readable storage medium, that, when executed, causes the first processing device to:
receive elevator status information from the elevator controller;
receive, from the device gateway, a modified configuration file associated with infotainment content to be displayed;
replace the configuration file with the modified configuration file; and
cause a display device inside the elevator car to display the infotainment content based on the modified configuration file or the elevator status information.

2. The elevator system of claim 1, wherein the elevator status information comprises a floor of the elevator car and a direction of travel of the elevator car.

3. The elevator system of claim 1, wherein the first processing device causes the display device to display the infotainment content based on an infotainment display file and the modified configuration file.

4. The elevator system of claim 3, wherein the infotainment display file comprises an HTML file and the modified configuration file comprises a JSON file.

5. The elevator system of claim 1, wherein the first processing device retrieves at least a portion of the infotainment content from one or more remote computing devices specified in the modified configuration file.

6. The elevator system of claim 1, wherein the first processing device causes the display device to display the elevator status information on a first display region of the display device, and to display the infotainment content on a second display region of the display device.

7. The elevator system of claim 1, wherein the device gateway comprises a second processing device, and a second non-transitory, processor-readable storage medium, that, when executed, causes the second processing device to:
receive an API command from a remote computing device;
parse the API command to determine whether the API command includes the modified configuration file; and
upon determination that the API command includes the modified configuration file, transfer the modified configuration file to the compute device.

8. A method comprising:
receiving elevator status information from an elevator controller associated with an elevator car;
receiving, from a device gateway, a modified configuration file associated with infotainment content to be displayed;
replacing a configuration file with the modified configuration file; and
causing a display device inside the elevator car to display the infotainment content based on the modified configuration file or the elevator status information.

9. The method of claim 8, wherein the elevator status information comprises a floor of the elevator car and a direction of travel of the elevator car.

10. The method of claim 8, further comprising displaying the infotainment content based on an infotainment display file and the modified configuration file.

11. The method of claim 10, wherein the infotainment display file comprises an HTML file and the modified configuration file comprises a JSON file.

12. The method of claim 8, further comprising retrieving at least a portion of the infotainment content from one or more remote computing devices specified in the modified configuration file.

13. The method of claim 8, further comprising causing the display device to display the elevator status information on a first portion of the display device, and to display the infotainment content on a second portion of the display device.

14. An system comprising:
a remote computing device; and
an elevator system comprising:
an elevator controller configured to control operation of an elevator car;
a device gateway; and
a compute device storing a configuration file;
wherein the compute device comprises a first processing device, and a first non-transitory, processor-readable storage medium, that, when executed, causes the first processing device to:
receive elevator status information from the elevator controller;
receive, from the device gateway, a modified configuration file associated with infotainment content to be displayed;
replace the configuration file with the modified configuration file; and
cause a display device inside the elevator car to display the infotainment content based on the modified configuration file or the elevator status information.

15. The system of claim 14, wherein the first processing device causes the display device to display the infotainment content based on an HTML file and the modified configuration file.

16. The system of claim 14, wherein the first processing device retrieves at least a portion of the infotainment content from one or more remote computing devices specified in the modified configuration file.

17. The system of claim 14, wherein the first processing device causes the display device to display the elevator status information on a first portion of the display device, and to display the infotainment content on a second portion of the display device.

18. The system of claim 14, wherein the device gateway comprises a second processing device, and a second non-transitory, processor-readable storage medium, that, when executed, causes the second processing device to:
receive an API command from the remote computing device;
parse the API command to determine whether the API command includes the modified configuration file; and
upon determination that the API command includes the modified configuration file, transfer the modified configuration file to the compute device.

19. The system of claim 14, wherein the remote computing device is configured to:
receive user updates associated with the infotainment content;
generate the modified configuration file based on the user updates; and
transmit the modified configuration file to the device gateway.

20. The system of claim 14, wherein the first processing device is further configured to:
receive emergency services information from the elevator controller; and
cause the display device to display the emergency services information.
